(19) United States
(12) Patent Application Publication
(10) Pub. No.: US 2021/0140226 A1
(43) Pub. Date: May 13, 2021

(54) SYSTEM FOR A CONFIGURABLE DOOR SILL

(71) Applicant: Endura Products, LLC, Colfax, NC (US)

(72) Inventor: Adam Kendall, Burlington, NC (US)

(73) Assignee: Endura Products, LLC, Colfax, NC (US)

(21) Appl. No.: 17/093,835

(22) Filed: Nov. 10, 2020

Related U.S. Application Data
(60) Provisional application No. 62/933,701, filed on Nov. 11, 2019.
(60) Provisional application No. 63/028,471, filed on May 21, 2020.

(51) Int. Cl. E06B 1/70; E06B 3/96

(52) U.S. Cl. CPC E06B 1/70; E06B 2001/707; E06B 3/9632

(57) ABSTRACT

A system, device, kit, assembly and methods for a frame assembly, including a door sill as shown and described. The assembly may be a door frame assembly and may, by way of example, be a door jamb and/or a door mullion including a door sill. Some inventions of the present disclosure may be a configurable door sill. In some embodiments, a door sill includes a base and a configurable insert component.

This application claims the benefit of Provisional Application Ser. No. 62/933,701 filed Nov. 11, 2019 and Provisional Application Ser. No. 63/028,471 filed May 21, 2020.

### FIELD OF THE TECHNOLOGY

The present disclosure relates generally to doors and door assemblies having a door sill for entranceways, for example, for a building and, more particularly, to improved configurable door sill apparatus, devices, kits, systems, and methods.

### BACKGROUND

A door sill takes constant and repeated traffic, weathering and abuse. Some parts of a door sill may wear faster than others and/or may be the focal point of more traffic flow. Important variables in door sill applications are a secure fit, ability to resist air and moisture penetration, durability, and resistance to weathering. Different applications often require different door sill designs.

It is desirable to minimize the number of parts needed and to maximize the ease of assembly and use for products intended for use in the building industry, by way of example in a door sill. Applicant realizes that providing a structure that also has flexibility in potential variants is also advantageous.

There is increased challenge when a door sill is configured to meet industry specific specifications, accessibility and/or code requirements.

Thus, Applicant recognized there remains a need for a cost effective, durable door sill that resists foot traffic, weathering and long-term exposure to moisture, and, in some embodiments, allows modularity in installation and use for a configurable door sill.

### SUMMARY

The present disclosure is directed in one embodiment to a system, device, method and/or kit for a door sill for a doorway. In some examples, a door sill may be considered a door sill assembly for an entryway door and may include a base component including an underlying structure for a sill assembly. The base component may include an upward facing channel configured to receive a mating projection of an insert component for interfacing variable component elements to the base. Interfacing the base with each of the insert component elements may result in a different sill configuration, each usable for a specific application. The interchangeability of the insert elements reduces cost, increases efficiency and operability, and decreases the number of parts required for installation while simultaneously increasing configurability.

Some embodiments include a door sill for an entryway including a base component and an insert cover component. A base component may include a length, a width, a top surface and a bottom surface, and a back and a front toward opposite ends of the base component along its width. The base component may include a wedge-shaped wall along the top surface of the base component. The wall on a front side, closer to the front, may include an angled edge, and the wall on a back side, closer to the back, may include a perpendicular wall.

The base component may include at least one chamber formed by a first chamber ledge, a second chamber ledge, and a chamber bottom.

The base component may include a lengthwise channel formed on one side by the perpendicular wall and extending between a first end and a second end, the first end and the second end located on opposite ends of the sill along its length.

The door sill includes an insert component, and in some embodiments, the insert component is removably attachable to the channel and selectably interchangeable depending on the requirements of the entryway.

The insert component may interface with the channel. The insert component may include a generally horizontal face. The generally horizontal face may be surrounded on each terminating end widthwise by a sloped surface. The generally horizontal face may be surrounded on one terminating end widthwise by a sloped surface and on the other terminating end covers a sloped surface.

The insert component may include a projection that secures into the channel.

In some embodiments, the base component may include a vertical wall along the back. The base component may include a vertical wall portion. The vertical wall may include a variable wall height. In some examples the insert provides the variable wall height with an accessory wall.

In some examples, the insert component includes a resilient sealing member. The insert component may include a generally horizontal top surface and a generally vertical interior facing surface.

Other examples include an insert component forming a sidelight seat for positioning a fixed panel.

The insert component, in some embodiments, may extend over a sloped surface. The insert component may include a sloped undersurface. The sloped undersurface may meet with a second sloped surface of the base component.

Still other examples include an insert component having a higher extension on the back than on the rest of the sill.

The base component may include a bottom cover for attachment to an underside of the door sill.

The door sill may interface with the base with each of the discrete insert component elements and may result in a different sill configuration, each usable for a specific application. Each variable insert component element may alternately combine with the base by interfacing mating projections with the channel, and when interfaced, forms a different overall shape for the sill assembly.

Multi-family projects and the use of accessible door sills are on the rise. Accessible door sills may, by way of example, meet qualifications for ADA compliance. Accessible door sills may require the use of thresholds which are typically no taller than ½ inches and contain a beveled 1:2 slope. While current offerings may help maintain compliance, they offer little else in terms of performance and adaptability. Such offerings are prone to leaks and hassles, requiring repairs ranging from slight, inadequate adjustments to total door system replacement. Further, Applicant realized with typical accessible sills, there is a lack of modularity or flexibility, by way of example, a large range of dedicated sills with different widths and styles are required to be kept on-hand in stock. This results in a high rate of repairs, project delays and increased expense for accessible sills. Applicant's sill, in some examples, includes accessible construction with enhanced performance against air and water infiltration. A sill may, in certain embodiments, be both accessible and water rated. Applicant's inventions may include an accessible, water rated sill, including modularity and flexibility with more than one insert cover components.

Examples of door sills may include sills having integral notches. Integral notches may be spaced along the base of a sill. In this example, the sill may be an oversized sill having an extended length. An end of the sill may be removed along the length at a notch to provide for a variable length sill. In some example, a sill may be formed to an extended length, longer than a standard sizing, by way of example, 7 9/16 inch, 6 9/16 inch, and sections of the base removed at a notch to size and adjust the length of the sill to a shorter length. The base may include supports along the underside of the base, spaced along with the integral notches to provide a support for the base. The supports may be descending in size from a first notch to a second notch, etc. along the base toward a decline end.

Some examples may include a door sill system according to any of the embodiments disclosed herein. The inventions of the present disclosure also include a door sill kit according to any of the embodiments disclosed herein. Methods for a configurable door sill according to any of the embodiments disclosed herein are also considered within the scope of this disclosure.

These and other aspects of the inventions of the present disclosure will become apparent to those skilled in the art after a reading of the following description of embodiments when considered with the drawings.

### BRIEF DESCRIPTION OF THE DRAWINGS

Embodiments of the disclosure will be better understood by a reading of the Description of Embodiments along with a review of the drawings, in which:

FIGS. 1-1A show an end view of one embodiment of examples a door sill for a doorway constructed according to the present disclosure;

FIGS. 2-2A show an end view of one embodiment of examples of the door sill of FIG. 1 including a resilient sealing member;

FIGS. 3-3A show an end view of embodiments of a door sill including an extended horizontal face;

FIGS. 4-4A show an end view of embodiments of a door sill including a raised horizontal face;

FIGS. 5-5A show an end view of embodiments of a door sill including a bottom cover;

FIG. 6 shows an end view of embodiments of a door sill including an insert cover having an outswing cap;

FIG. 7 shows an end view of embodiments of a door sill including a sill extender;

FIG. 8 shows a perspective end view of a door sill according to one example of the present disclosure;

FIGS. 9A-9D shows one example of a jamb boot for a door sill according to the present disclosure;

FIG. 10 shows an end view of one example of a door sill including adaptive features according to the present disclosure;

FIG. 11 shows one example of a door sill with interchangeable caps;

FIG. 12 shows an end view of one example of a door sill according to embodiments of the present disclosure;

FIG. 13 shows one example of a door sill including an extended length and having integral notches according to the present disclosure; and

FIG. 14 shows one example of a jamb boot for a door sill including integral boot notches according to the present disclosure.

### DESCRIPTION OF EMBODIMENTS

In the following description, like reference characters designate like or corresponding parts throughout the several views. Also, in the following description, it is to be understood that such terms as “forward,” “rearward,” “left,” “right,” “upwardly,” “downwardly,” and the like are words of convenience and are not to be construed as limiting terms.

A door frame often includes one or more frame members. A plurality of frame members may include any combination of a header, a sill, mullion components, jamb components, and/or a trim profile. A header may be generally placed toward the top of a door assembly. Mullions and jambs components may be generally placed at opposing sides of a door assembly. Frame assemblies may also include hinges for connecting door panels to at least one of the frame members. The frame assembly may also include locking and latching plates that enable the door to be secured to as least one of the frame members and/or to another frame member. Locking hardware, by way of example, latches and deadbolts may engage the locking plates. Toward the bottom of a doorway typically is a door sill assembly.

Referring now to the drawings in general, it will be understood that the illustrations are for the purpose of describing a preferred embodiment of the inventions and are not intended to limit the inventions thereto. Shown throughout FIGS. 1-1A, and referencing a door sill 10, in some embodiments, a door sill 10 may include a base component 12. The base component 12 may be a molded base component. The base component 12, in some examples, may be an extruded component. The base component 12, may be an aluminum extrusion.

A base component 12 may include a length L, a width W, a top surface 18 and a bottom surface 19. The base component 12 may include a back 15 and a front 16, located toward opposite ends of the base component along its width W. The base component 12 may include a first end 21 and a second end 23, located toward opposite ends of the base component along its length L.

In some embodiments, the base component 12 includes a vertical wall 20 along the back 15. An angled wall 22 may extend from the vertical wall 20. The angled wall 22 may connect to an insert support 24. Insert support 24 may include an opening to a chamber 30. The opening may be formed along the top surface 18 by a first ledge 28 and a second ledge 26, and enclosed along the bottom by a chamber bottom 57. There may be an opening between the first channel ledge 28 and the second channel ledge 26. The chamber 30 may provide a thermal break cavity when the chamber bottom 57 is removed.

A channel 32 may extend downwardly from the top surface 18. The channel 32 may be a lengthwise channel, extending from a first end 21 to a second end 23 along the length L. The second channel ledge 26, a channel bottom 59, a perpendicular wall 40, and a second wall 41, may frame the channel 32.

A linear segment 42 may adjoin a wedge-shaped wall 44 along the top surface. The wedge-shaped wall 44 on a front, closer to the front 16, may include an angled edge 43, and on a back side, closer to the back, include the perpendicular wall 40, and be separated apart by the linear segment 42. The wedge-shaped wall 44 may intersect with an angled segment 46 along the top surface 18.

An extender cavity 53 may be formed at the front 16. The extender cavity 53 may include a top lip 49 and a bottom lip 52. The top lip 49 and the bottom lip 52 may be discontinuous in some examples.

A bottom surface 19 may include various screw bosses, by way of example, 60, and supports 62, 54, 56, 58, along the width W.

An insert cover component 70 may be attachable to the base component 12. A set of insert cover components may be included in a configurable door sill system and/or kit. An insert cover component 70 may be removably attachable to the base component 12. A mating projection 72 extending from the insert cover component 70 may mate with the channel 32 and secure the insert cover component to the base component.

In one example, a base component 12 includes an underlying structure for the sill assembly, including an upward facing channel 32 formed in the base component 12. A mating projection 72 extends from the insert cover component 70, and the upward facing channel 32 is configured to receive the mating projection 72 of the insert cover component for interfacing variable insert component elements to the base 12. The mating projection 72 may include securing prongs 74. In one embodiment, when interfacing the base with each of the variable insert component elements may result in a different sill configuration, each usable for a specific application. In one example, when each variable insert cover component 70 element combines with the base by interfacing mating projection 72 with the channel 32, forms a different overall shape for the sill assembly. Varying elements of the insert cover component 70 embodiment elements, by way of example, may be seen in FIG. 1 where the insert cover component includes a generally horizontal face 27; FIG. 2 with a resilient sealing member 75 attached to the face 27; FIG. 3 with an extended horizontal face 80, FIG. 4 including a an accessory wall 81; FIG. 5 including a bottom cover 95; FIG. 6 including an outswing cap 100; and FIG. 7 including a sill extender 115.

As shown in FIGS. 1 and 1A, an insert cover component 70 in some examples may include a generally horizontal face 27 and a mating projection 72. The insert cover component 70 may cover the chamber 30. The insert cover may cover the channel 32. The generally horizontal face 27 may be situated between an angled wall 22 on one side and a wedge-shaped wall 43 on the other side.

FIGS. 2 and 2A show an insert cover component 70 including a resilient sealing member 75. Resilient sealing member 75 may curve upward forming a flexible sealing element along the door sill 10. The generally horizontal face 27 may taper at one or at both sides.

FIGS. 3 and 3A show examples of an insert cover component 70 including an extended horizontal face 80 and an accessory wall 81. Extended horizontal face 80 may extend to cover angled wall 22 and to form a substantially linear top surface 18 in an upper plane P2 of the top surface 18. Accessory wall 81 may align with vertical wall 20 to form a higher back that in use forms a sill with a tile back adapter (see also FIGS. 10 and 11). Accessory wall 81 may include an accessory wall base 82.

FIGS. 4 and 4A shows examples of an insert cover component 70 including a raised generally horizontal face 85 having a space between insert support 24 and the face 85. Raised generally horizontal face 85 may include an insert extension 88, at least partially supporting horizontal face 85 in an elevated position. An elevated back 87 may attach to face 85 and may extend accessory wall 81. Insert front 90 may cover wedge shaped wall 44 to form a substantially perpendicular interface with front insert face 91 to cover the wedge-shaped wall 44. In use, the raised horizontal face 85 forms a sill with a sidelite panel seat.

FIGS. 5 and 5A show examples of a door sill 10 including a bottom cover 95. Bottom cover 95 may extend along a bottom surface 19. Bottom cover 95 may enclose a space along the underside of the base component 12. One or more fingers 96 may wedge the bottom cover 95 into a secured position. In use, bottom cover 95 may serve as a caulking strip for door sill 10. Bottom cover ends 98 may extend beyond fingers 96 to secure bottom cover 95.

FIG. 6 shows examples of a door sill 10 including an insert cover component 70. Insert cover component 70 may include a mating projection 72 and an outswing cap 100. Outswing cap 100 may form an angled surface from cap top 106 to cap end 105. Outswing cap 100 may extend over a top surface in a first plane P1 of top surface 18 of the base component 12. An angled face 102 of insert cover component 72 extends angularly toward the front of base component 12 and attached to a first wall 107 that forms one side of a triangular shaped cap 101, including first wall 107, second wall 103 and third wall 104.

FIG. 7 shows embodiments of a door sill 10 having an insert cover component 70 and a sill extender 115.

In one example, the base 12 may be an extruded aluminum deck component, structured according to any of the embodiments disclosed, such that the door sill 10 maintains a secure fit with a door panel, minimizes materials needed for construction of the sill, is durable and damage resistant and is cost effective, reducing production cost of the door sill 10.

FIGS. 9A-9D show examples of a jamb boot 120. A jamb boot 120 may provide an interface between a door jamb 130 and sill to prevent water infiltration. Jamb boot 120 may include a sealing beak 122. The sealing beak 122 may sit beneath a weather strip and be adapted to block upward water pressure, thus preventing resulting infiltration. Jamb boot 120 may include a sealing gasket 125. The sealing gasket 125, in one example, may be a foam sealing gasket. The sealing gasket 125 may provide a weathertight seal at a jamb and sill interface, between the base of a jamb boot and an edge of a sill. The jamb boot 120 may attach to an end of a sill on one side of the jamb boot and the jamb boot 120 may accept a jamb along a top surface of the jamb boot. The sealing gasket 125 may line the interface between the jamb boot and the sill along an underside of the jamb boot. The sealing gasket may be pre-applied. The sealing gasket 125 may provide sealing without the use and additions of caulk.

In one example, a jamb boot 120 may include pre-drilled screw locations. The pre-drilled screw locations may result in a more secure corner assembly for a jamb and sill when fasteners are installed within the pre-drilled screw locations.

A door sill 10 may include, in some examples as shown in FIG. 13, one or more integral notches. Integral notches 137 may be spaced along the base 12 of a sill 10, in some examples, along an underside of the sill. In this example, the sill 10 may be an oversized sill having an extended length base 12. An end 16 of the sill may be removed along the length at a notch 137 to provide for a variable length sill. In some examples, a sill 10 may be formed to an extended length, longer than a standard sizing, by way of example 7 9/16 inch, and sections of the base 12 removed at a notch 137 to size and adjust the length of the sill to a shorter length. The base 12 may include supports 135 along the underside of the base, spaced along the base with the integral notches 137 to provide a support for the base. The supports may be descending in size from a first notch to a second notch, etc. along the base toward an end 16. The supports 135 may be variable sizes. The extended length base may allow the door sill 10 to be adjustable in length by being cut along the length of the base.

A jamb boot 120 (an of example as seen in FIG. 14) may include boot notches 137′ to allow the jamb boot 120 to be adjustable for material to be removed to match the sizing of the jamb and/or base 12 when a portion of the length of the base 12 is removed at the notch 137 for a shorter length sill 10.

Some embodiments, examples as seen in FIGS. 10-12, include a sill 10 with flexibility and modularity with a base 12 having removable and interchangeable insert cover components 70. In one example, the base 12 may be a single base design that works with removable, interchangeable insert cover components 70 to provide the option to change the sill type between different modalities and functionalities. In one example, the sill 10 may be interchangeable between a standard back and a tileback. In another example, a sidelite cap may be added or removed either in the shop or in the field through insert cover component 70 interchangeability with the same base 12.

Sill 10 may provide inswing and outswing exchangeability, wherein an inswing sill 10 profile may be reversed to support outswing applications. A sill extender 115 capability, provides that, in some examples, extenders 115 of 2 inches and 3 inches in length may fit with a base 12 to deliver widths ranging from 6 9/16 inches to 8⅝ inches.

Examples may include an accessible sill 10. This may require the use of thresholds which are no taller than ½ inches contain a beveled 1:2 slope. A sill may be accessible and may include a full-length caulking strip for a complete barrier beneath the sill, a jamb boot 120 (and in other examples a mullion boot) with a sealing beak and a pre-applied sealing gasket to prevent leaks at the most common locations and support stronger lower corner assemblies. In certain embodiments, a sill 10 may be accessible and with a single-base design with removable, interchangeable insert cover components 70, by way of example, non-tileback, tileback and sidelights caps. Such flexibility provides on-the-spot cap replacement in the field, allowing installers to change a sill type from “standard” to tileback without replacing the sill or door system. A sill 10 may be accessible and compatible with different size extenders 115, by way of example, compatible with 2 inch and 3 inch extenders, for increased flexibility and efficiency and options in accessible sills. The sill 10 may be an accessible sill having a water rating.

The inventions of the present disclosure may be considered a method for a door sill 10 for a doorway by way of any of the embodiments disclosed. The inventions also include a method for an economical door sill 10.

The scope of the present disclosure is also considered to include a kit for a configurable door sill according to any of the embodiments disclosed herein.

The scope of the present disclosure is also considered to include a system for a configurable door sill according to any of the embodiments disclosed herein. The scope of the present disclosure is also considered to include jamb and mullion embodiments of the sill 10 and the boot 120.

Certain modifications and improvements will occur to those skilled in the art upon a reading of the foregoing description. It should be understood that all such modifications and improvements have been deleted herein for the sake of conciseness and readability but are properly within the scope of the following claims.

We claim:

1. A door sill for an entryway comprising:
a base component, said base component having a length, a width, a top surface and a bottom surface;
a back and a front toward opposite ends of the base component along its width;
a wedge-shaped wall along the top surface of said base component, wherein the wall on a front side, closer to the front, includes an angled edge, and the wall on a back side, closer to the back, includes a perpendicular wall;
a lengthwise channel formed on one side by the perpendicular wall and extending between a first end and a second end, the first end and the second end located on opposite ends of the sill along its length;
an insert cover component, said insert cover component removably attachable to the channel and selectably interchangeable depending on the requirements of the entryway.

2. The door sill of claim 1 wherein said insert component interfaces with the channel.

3. The door sill of claim 2 wherein said insert component includes a generally horizontal face.

4. The door sill of claim 3 wherein said face is surrounded on each terminating end widthwise by a sloped surface.

5. The door sill of claim 3 wherein said face is surrounded on one terminating end widthwise by a sloped surface and on the other terminating end covers a sloped surface.

6. The doorway of claim 2 including a projection that secures into the channel.

7. The doorway of claim 6 including a vertical wall along the back.

8. The doorway of claim 7 wherein the insert includes a vertical wall portion.

9. The doorway of claim 8 wherein the vertical wall includes a variable wall height.

10. The doorway of claim 9 wherein the insert provides the variable wall height with an accessory wall.

11. The door sill of claim 2 wherein said insert component includes a resilient sealing member.

12. The door sill of claim 2 wherein said insert component includes a generally horizontal top surface and a generally vertical interior facing surface.

13. The door sill of claim 2 wherein said insert component forms a sidelight seat for positioning a fixed panel.

14. The door sill of claim 2 wherein the insert extends over a sloped surface.

15. The door sill of claim 14 wherein the insert includes a sloped undersurface.

16. The door sill of claim 15 wherein the sloped undersurface meets with a second sloped surface of the base component.

17. The door sill of claim 1 wherein said door sill is an accessible door sill.

18. The door sill of claim 17 including a water rating.

19. A door sill assembly for a doorway, comprising:
a base component including an underlying structure for the sill assembly, an upward facing channel formed in the base component,
a mating projection, wherein the upward facing channel is configured to receive the mating projection of the insert component for interfacing discrete insert component elements to the base.

20. The door sill assembly of claim 20 wherein each discrete insert component element combines with the base by interfacing a mating projection with the channel and when interfaced, forms a different overall shape for the sill assembly.

21. The door sill assembly of claim 20 wherein interfacing the base with each of the discrete insert component elements may result in a different sill configuration, each usable for a specific application.

22. The door sill of claim 21 wherein said base is an extended length base that is adjustable at included integral notches.

23. The door sill of claim 21 including a jamb boot having integral boot notches.
